(19) United States
(12) Patent Application Publication
(10) Pub. No.: US 2023/0314903 A1
(43) Pub. Date: Oct. 5, 2023

(54) OPTICAL ELEMENT DRIVING APPARATUS, CAMERA MODULE, AND CAMERA-MOUNTED APPARATUS

(71) Applicants: Masayoshi SUGAWARA, Tokyo (JP); Kugo KUMAGAI, Tokyo (JP)

(72) Inventors: Masayoshi SUGAWARA, Tokyo (JP); Kugo KUMAGAI, Tokyo (JP)

(73) Assignee: Mitsumi Electric Co., Ltd., Tokyo (JP)

(21) Appl. No.: 18/127,022

(22) Filed: Mar. 28, 2023

(30) Foreign Application Priority Data
Mar. 29, 2022 (JP) 2022-054161

(51) Int. Cl. G03B 13/36; G03B 5/00

(52) U.S. Cl. CPC G03B 5/00; G03B 13/36; G03B 30/00; G03B 2205/0007

(57) ABSTRACT

The optical element driving apparatus includes: a fixing part; a movable part allowing an optical element to be held therein; a plurality of support members supporting the movable part with respect to the fixing part; and a driving part that moves the movable part in a direction of an optical axis. The plurality of support members is formed of an elastic resin material, and each of the plurality of support members includes a movable-side connection part, which is connected to the movable part, and a fixed-side connection part, which is connected to the fixing part. A plurality of the movable-side connection parts and a plurality of the fixed-side connection parts are alternately arranged in a circumferential direction around the optical axis.

### CROSS REFERENCE TO RELATED APPLICATIONS

This application claims the benefit of priority of Japanese Patent Application No. 2022-054161 filed on Mar. 29, 2022, the contents of which are incorporated by reference as if fully set forth herein in their entirety.

### TECHNICAL FIELD

The present invention relates to an optical element driving apparatus, a camera module, and a camera-mounted apparatus.

### BACKGROUND ART

In general, a small-sized camera module is mounted in a mobile terminal such as a smartphone. To such a camera module, an optical element driving apparatus is applied which has an auto-focusing function (hereinafter referred to as “AF (Auto Focus) function”) of automatically performing focusing when a subject is photographed, and a shake-correcting function (hereinafter referred to as “OIS (Optical Image Stabilization) function”) of reducing irregularities of an image by optically correcting shake (vibration) generated during photographing (for example, see Patent Literature (hereinafter referred to as “PTL”) 1).

The optical element driving apparatus includes: a fixing part; a movable part that allows an optical element to be held therein; a support part that supports the movable part with respect to the fixing part; and a driving part that moves the movable part in a direction of an optical axis (hereinafter may also be referred to as “optical axis direction”). PTL 1 discloses an optical element driving apparatus to which an elastic support member having a hinge structure is applied as a support part.

### CITATION LIST

### Patent Literature

PTL 1: WO 2018/135423

### SUMMARY OF INVENTION

### Technical Problem

In the optical element driving apparatus disclosed in PTL 1, however, since the movable part is supported, by the elastic support member, in a cantilever state with respect to the fixing part, the optical axis may deviate in a case where the elastic support member thermally expands. In a case where the optical axis deviates, shake correction is not performed properly and image-capturing accuracy decreases.

An object of the present invention is to provide an optical element driving apparatus, a camera module, and a camera-mounted apparatus each capable of preventing an optical axis deviation and achieving an improved image-capturing accuracy.

### Solution to Problem

An optical element driving apparatus according to the present invention includes: a fixing part; a movable part that allows an optical element to be held therein; a plurality of support members that supports the movable part with respect to the fixing part; and a driving part that moves the movable part in a direction of an optical axis. The plurality of support members is formed of an elastic resin material, and each of the plurality of support members includes a movable-side connection part, which is connected to the movable part, and a fixed-side connection part, which is connected to the fixing part. A plurality of the movable-side connection parts and a plurality of the fixed-side connection parts are alternately arranged in a circumferential direction around the optical axis.

A camera module according to the present invention includes: the optical element driving apparatus described above; a lens part that is attached to the movable part; and an image-capturing part that captures a subject image formed by the lens part.

A camera-mounted apparatus according to the present invention is an information device or a transport device. The camera-mounted apparatus includes: the camera module described above; and a control part that controls an operation of the camera module.

### Advantageous Effects of Invention

According to the present invention, it is possible to prevent an optical axis deviation and achieve an improved image-capturing accuracy.

### BRIEF DESCRIPTION OF DRAWINGS

FIGS. 1A and 1B illustrate a smartphone in which a camera module according to an embodiment of the present invention is mounted;

FIG. 2 is an external perspective view of the camera module;

FIG. 3 is an exploded perspective view illustrating a schematic configuration of the camera module;

FIG. 4 is an exploded perspective view illustrating a schematic configuration of an optical element driving apparatus;

FIG. 5 is an exploded perspective view illustrating a schematic configuration of an OIS movable part (AF unit);

FIG. 6 is an exploded perspective view illustrating the schematic configuration of the OIS movable part (AF unit);

FIGS. 7A and 7B are plan views of the AF unit;

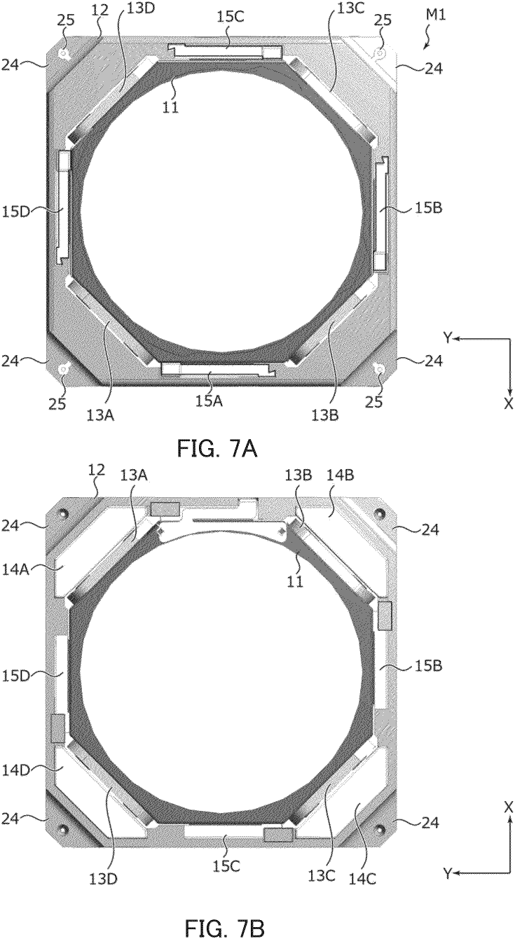

FIGS. 8A and 8B are perspective views illustrating a fixing aspect of an elastic support member with respect to a lens holder;

FIGS. 9A and 9B are perspective views illustrating a fixing aspect of the elastic support member with respect to a magnet holder;

FIG. 10 is a plan view illustrating a fixing aspect of the elastic support member with respect to the lens holder and the magnet holder; and

FIGS. 11A and 11B illustrate an automobile as a camera-mounted apparatus in which an in-vehicle camera module is mounted.

### DESCRIPTION OF EMBODIMENTS

Hereinafter, a preferred embodiment of the present invention will be described in detail with reference to the accompanying drawings.

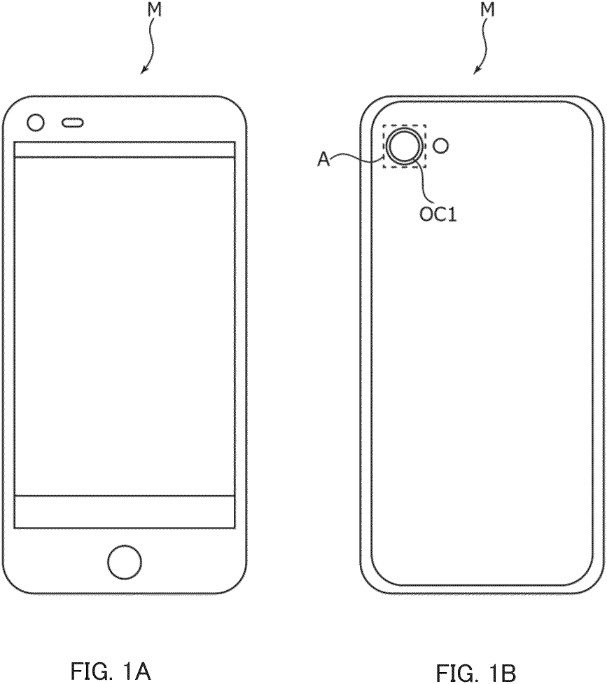

FIGS. 1A and 1B illustrate smartphone M (an example of the camera-mounted apparatus) in which camera module A is mounted according to an embodiment of the present invention. FIG. 1A is a front view of smartphone M, and FIG. 1B is a rear view of smartphone M.

In the present embodiment, camera module A is applied to rear camera OC1 of smartphone M. Camera module A has the AF function and the OIS function, and is capable of photographing an image without image blurring by automatically performing auto-focusing when a subject is photographed and by optically correcting shake (vibration) generated during photographing.

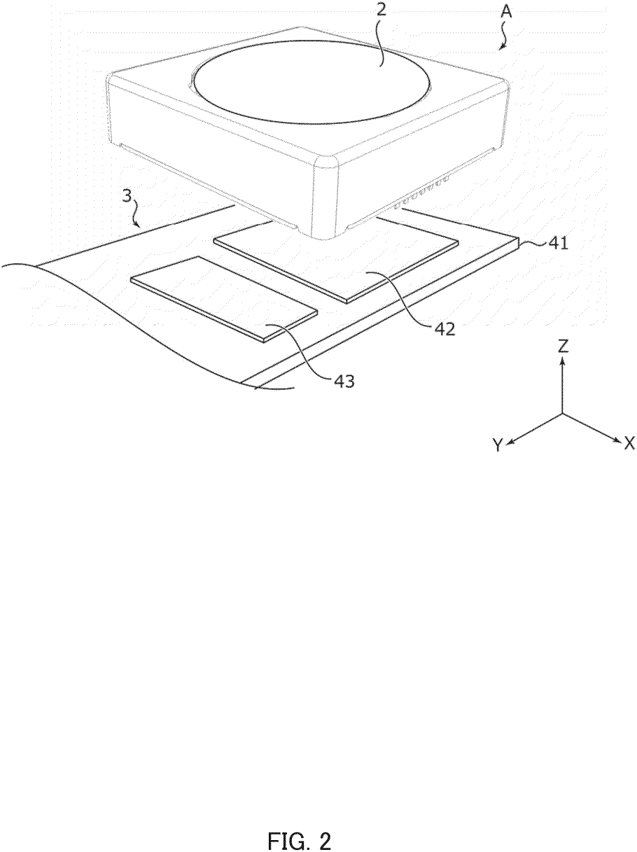

FIG. 2 is an external perspective view of camera module A. As illustrated in FIG. 2, in the embodiment, a description will be given using a left orthogonal coordinate system (X, Y, Z) in which a light reception side in the optical axis direction is the positive side of the Z-axis and an image formation side in the optical axis direction is the negative side of the Z-axis. The same orthogonal coordinate system (X, Y, Z) is also used in the drawings to be described later. Hereinafter, “the X-axis direction”, “the Y-axis direction”, and “the Z-axis direction” mean the positive directions of the X-axis, Y-axis, and Z-axis, respectively. Camera module A is mounted in the camera-mounted apparatus such that the X-axis represents up-down (or left-right), the Y-axis represents left-right (or up-down), and the Z-axis represents front-rear.

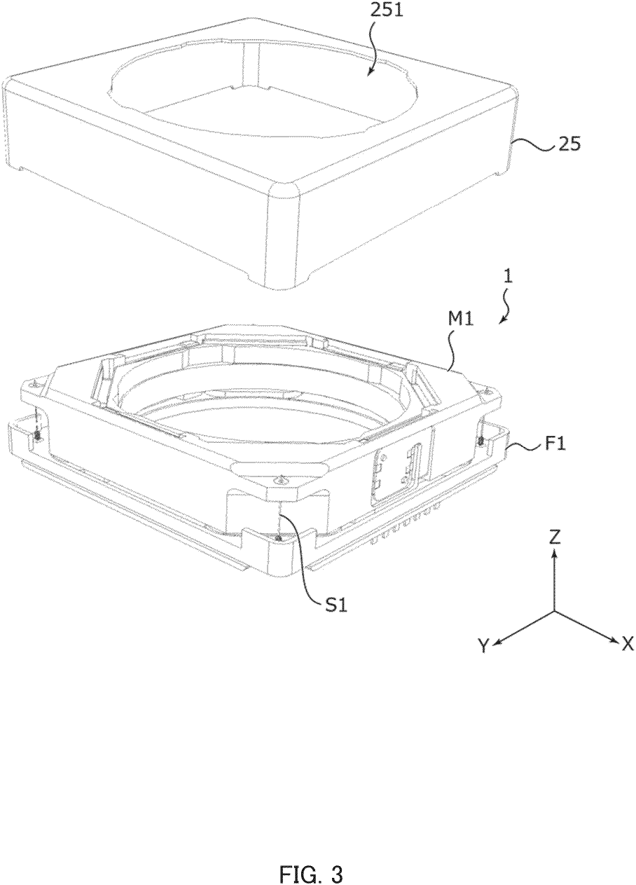

Camera module A includes: optical element driving apparatus 1 (see FIG. 3) that realizes the AF function and the OIS function; lens part 2 in which a lens is housed in a lens barrel having a cylindrical shape; and image-capturing part 3 that captures a subject image formed by lens part 2, or the like.

Image-capturing part 3 is disposed on the image formation side in the optical axis direction of optical element driving apparatus 1. Image-capturing part 3 includes, for example, image sensor board 41, image-capturing element 42, control part 43 that performs driving control of optical element driving apparatus 1, or the like. Optical element driving apparatus 1 is mounted in image sensor board 41 and is mechanically and electrically connected thereto. Image-capturing element 42 is formed of, for example, a charge-coupled device (CCD) image sensor, a complementary metal oxide semiconductor (CMOS) image sensor, or the like. Image-capturing element 42 is implemented in image sensor board 41 and captures a subject image formed by lens part 2. Control part 43 performs the driving control of optical element driving apparatus 1. Control part 43 may be implemented in image sensor board 41 or may be provided in the camera-mounted apparatus (smartphone M in the embodiment) in which camera module A is mounted.

FIG. 3 is an exploded perspective view illustrating a schematic configuration of the camera module. As illustrated in FIG. 3, the outer side of a driving apparatus body (whose reference sign is omitted) of optical element driving apparatus 1 is covered with cover 25. Cover 25 is a capped square cylindrical body having a rectangular shape in plan view when viewed in the optical axis direction, and includes opening 251 in the upper surface. Lens part 2 faces the outside through opening 251 described above. Cover 25 is fixed to base 21 of optical element driving apparatus 1 by, for example, adhesion. That is, optical element driving apparatus 1 has a rectangular shape extending in the X-axis direction and the Y-axis direction in plan view when viewed in the optical axis direction. Hereinafter, the “plan view” means a plan view when viewed in the optical axis direction.

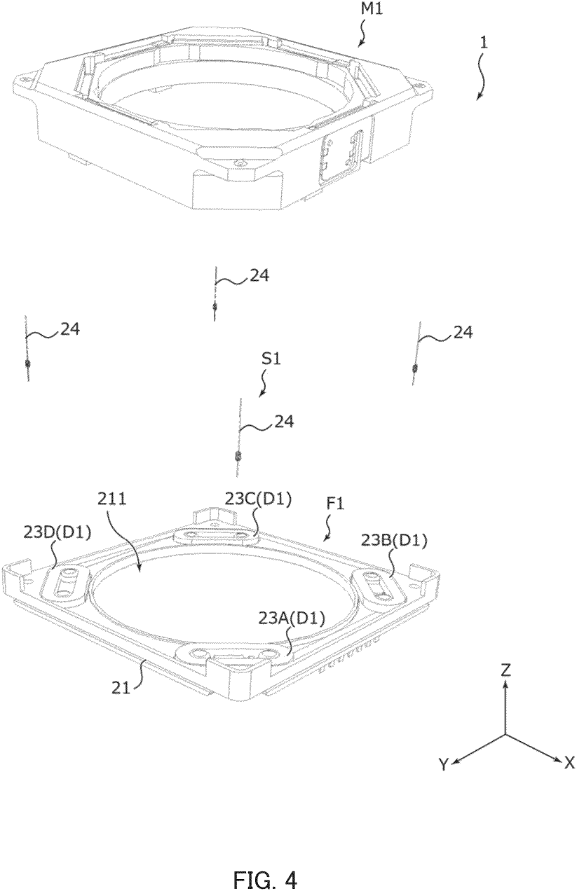

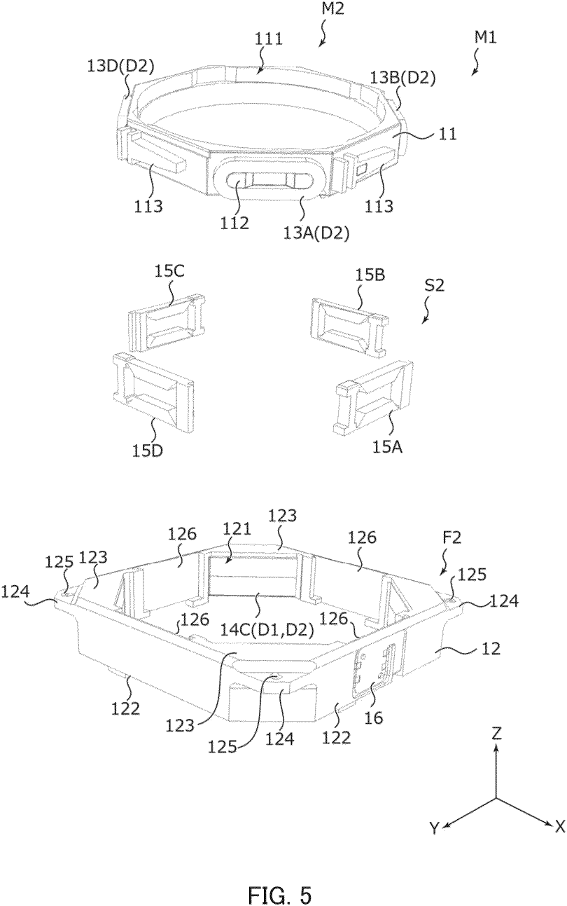

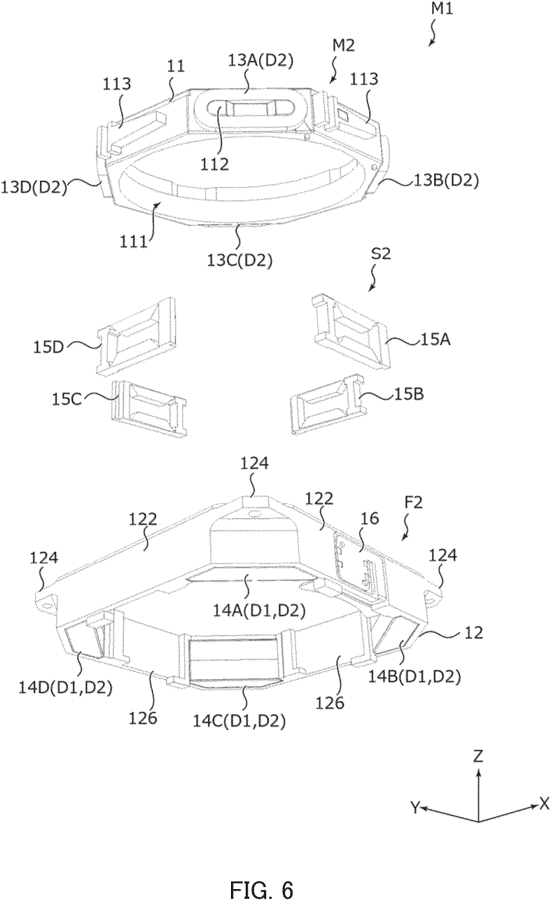

FIG. 4 is an exploded perspective view illustrating a schematic configuration of optical element driving apparatus 1. FIGS. 5 and 6 are exploded perspective views illustrating a schematic configuration of OIS movable part M1. Note that, cover 25 is omitted in FIG. 4.

As illustrated in FIGS. 4 to 6, optical element driving apparatus 1 includes OIS fixing part F1, OIS movable part M1, OIS driving part D1, and OIS support part S1.

OIS movable part M1 is a portion that receives the driving force of OIS driving part D1 to sway within an optical axis-orthogonal plane during shake correction. In the present embodiment, OIS movable part M1 is formed of a so-called AF unit including AF movable part M2, AF fixing part F2, AF driving part D2, and AF support part S2.

OIS fixing part F1 is a portion that supports OIS movable part M1 via OIS support part S1. For example, OIS fixing part F1 is disposed so as to be separated from OIS movable part M1 on the image formation side in the optical axis direction. OIS fixing part F1 includes base 21.

OIS support part S1 is a portion that supports OIS movable part M1 such that OIS movable part M1 is capable of swaying with respect to OIS fixing part F1 within the optical axis-orthogonal plane (within the XY plane). For example, OIS support part S1 is formed of four suspension wires 24 disposed at four corners.

OIS driving part D1 is a portion that drives OIS movable part M1 during shake correction. OIS driving part D1 is formed of, for example, OIS coils 23A to 23D disposed in OIS fixing part F1, and driving magnets 14A to 14D (see FIG. 6 or the like) disposed in OIS movable part M1. That is, a voice coil motor of a moving magnet system is applied to OIS driving part D1 of the present embodiment. Note that, OIS driving part D1 may be formed of a voice coil motor of a moving coil system.

AF movable part M2 is a portion that receives the driving force of AF driving part D2 to move in the optical axis direction during auto-focusing. AF movable part M2 includes lens holder 11.

AF fixing part F2 is a portion that supports AF movable part M2 via AF support part S2. AF fixing part F2 is disposed, for example, so as to be separated outward in the radial direction from AF movable part M2. AF fixing part F2 includes magnet holder 12.

AF support part S2 is a portion that movably supports AF movable part M2 in the optical axis direction with respect to AF fixing part F2. AF support part S2 includes four elastic support members 15A to 15D.

AF driving part D2 is a portion that drives AF movable part M2 during auto-focusing. AF driving part D2 is formed of, for example, AF coils 13A to 13D disposed in AF movable part M2, and driving magnets 14A to 14D disposed in AF fixing part F2. That is, a voice coil motor of a moving coil system is applied to AF driving part D2 of the present embodiment. Note that, AF driving part D2 may be formed of a voice coil motor of a moving magnet system.

Specifically, optical element driving apparatus 1 includes lens holder 11, magnet holder 12, AF coils 13A to 13D, driving magnets 14A to 14D, elastic support members 15A to 15D, base 21, OIS coils 23A to 23D, suspension wires 24, or the like.

Lens holder 11 is a member that functions as AF movable part M2, and holds lens part 2 (see FIG. 2) in lens housing part 111 having a tubular shape. Lens part 2 is fixed to lens housing part 111 by adhesion or screwing. In the present embodiment, lens holder 11 has a substantially octagonal outer shape in plan view.

On the peripheral surface of lens holder 11, coil attachment parts 112, to which AF coils 13A to 13D are attached, and support member attachment parts 113 to which elastic support members 15A to 15D are attached, are alternately provided. In plan view, coil attachment parts 112 are arranged to face each other in a first direction and a second direction that are obtained by rotating the X-axis direction and the Y-axis direction by 45° around Z-axis. Support member attachment parts 113 are arranged to face each other in the X-axis direction and the Y-axis direction.

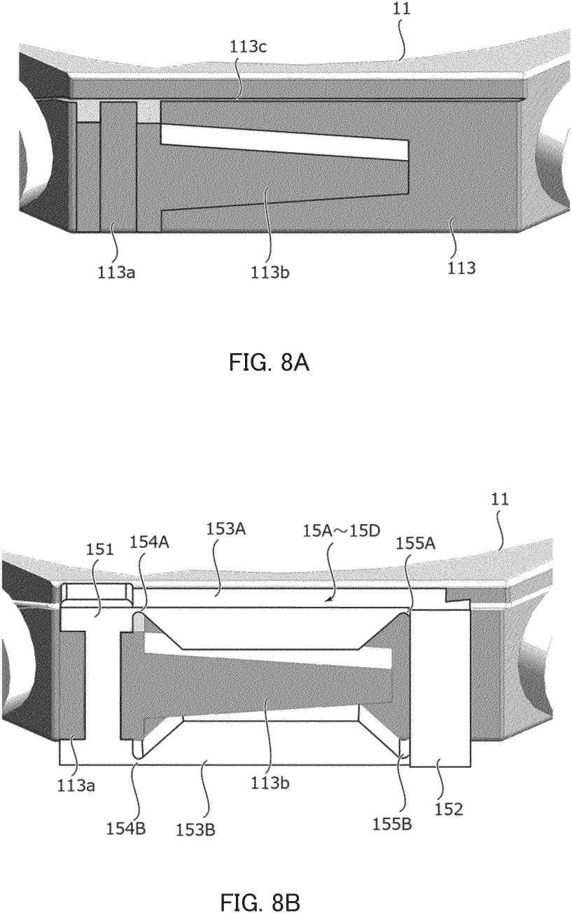

Support member attachment part 113 includes: engagement part 113a with which movable-side connection part 151 of elastic support members 15A to 15D engages; and reinforcement protrusion part 113b that is located between arm parts 153A and 153B of elastic support members 15A to 15D (see FIG. 8A). Reinforcement protrusion part 113b has a tapered shape such that the width of reinforcement protrusion part 113b in the optical axis direction narrows from a side of a base end of reinforcement protrusion part 113b, at which engagement part 113a is present, toward a side of a leading end of reinforcement protrusion part 113b. Thus, elastic support members 15A to 15D are allowed to be deformed in the optical axis direction and AF movable part M2 is movable in the optical axis direction.

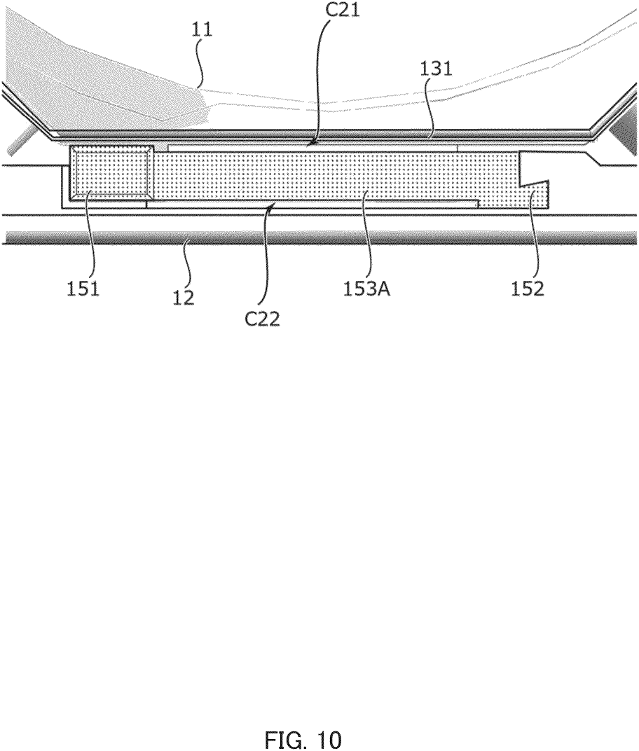

Further, the upper portion of support member attachment part 113 is provided with stepped part 113c extending in the circumferential direction. Coil wiring 131 that couples AF coils 13A to 13D to each other is routed around stepped part 113c (see FIG. 10).

Magnet holder 12 is a holding member having a substantially rectangular tubular shape in plan view, in which four side wall bodies 122 are coupled together. Magnet holder 12 includes opening 121 in which portions corresponding to the substantially octagonal outer shape of lens holder 11 in plan view are notched.

Magnet holder 12 includes magnet holding parts 123 on the inner sides of coupling parts (four corners of magnet holder 12) of four side wall bodies 122. Driving magnets 14A to 14D are fixed to magnet holding parts 123. Magnet holding parts 123 are provided with, for example, openings (whose reference sign is omitted) communicating with the outside, which allows an adhesive to be injected into the contact surfaces between magnet holding parts 123 and driving magnets 14A to 14D.

Magnet holder 12 includes, at the coupling parts of side wall bodies 122, wire connection parts 124 having a flange shape projecting outward in the radial direction. A space recessed inward in the radial direction is formed on the image formation side in the optical axis direction of wire connection part 124. Thus, it is possible to avoid interference between suspension wire 24 and magnet holder 12 when OIS movable part M1 sways.

Further, a plurality (for example, four) of wirings 125 for power supply to AF coils 13A to 13D and power supply control is embedded in magnet holder 12, for example, by insert molding. One end of wiring 125 is exposed from wire connection part 124 and is electrically connected to suspension wire 24. The other end of wiring 125 is electrically connected to a control IC (whose reference sign is omitted) implemented in control board 16.

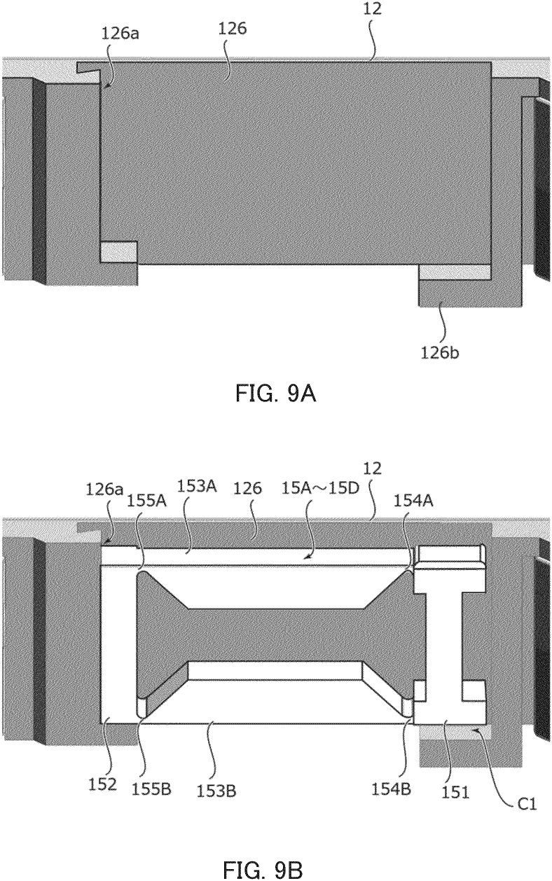

In magnet holder 12, support member housing parts 126 for fixing elastic support members 15A to 15D are provided on the inner peripheral surfaces of side wall bodies 122. Support member housing part 126 includes: engagement part 126a with which fixed-side connection part 152 of elastic support members 15A to 15D engages; and stopper part 126b that regulates movement of AF movable part M2 to the image formation side in the optical axis direction (see FIG. 9A). Stopper part 126b is located on the image formation side in the optical axis direction with respect to a bottom surface of engagement part 126a.

AF coils 13A to 13D are air-core coils in which current flows during auto-focusing, and are disposed in coil attachment parts 112 of lens holder 11. AF coils 13A to 13D and driving magnets 14A to 14D form a voice coil motor that functions as AF driving part D2. AF coils 13A to 13D are coupled to each other, and both ends thereof are electrically connected to the control IC (whose illustration is omitted) implemented in control board 16. Current flows in AF coils 13A to 13D via, for example, suspension wires 24, wirings 125 embedded in magnet holder 12, and the control IC (whose illustration is omitted).

Driving magnets 14A to 14D are fixed to magnet holding parts 123 of magnet holder 12 by, for example, adhesion. Driving magnets 14A to 14D have, for example, a substantially isosceles trapezoid shape in plan view. Thus, it is possible to effectively utilize the spaces (magnet holding parts 123) at the corner parts of magnet holder 12.

Driving magnets 14A to 14D are disposed so as to be separated from AF coils 13A to 13D in the radial direction, respectively, and are disposed so as to be separated from OIS coils 23A to 23D in the optical axis direction, respectively. Driving magnets 14A to 14D are magnetized such that magnetic fields crossing AF coils 13A to 13D in the radial direction (the first direction or the second direction) and crossing OIS coils 23A to 23D in the optical axis direction are formed. Driving magnets 14A to 14D and AF coils 13A to 13D form a voice coil motor that functions as AF driving part D2. Further, driving magnets 14A to 14D and OIS coils 23A to 23D form a voice coil motor that functions as OIS driving part D1. In other words, in the present embodiment, driving magnets 14A to 14D serve as AF magnets and OIS magnets.

Elastic support members 15A to 15D elastically support lens holder 11, which is AF movable part M2, with respect to magnet holder 12, which is AF fixing part F2. Elastic support members 15A to 15D are formed of an elastic resin material such as an elastomer. Thus, the resistance to impact such as a drop improves.

As the elastic resin material, a thermoplastic elastomer (for example, a polyester-based elastomer) that allows a small spring constant to be designed, allows injection molding, and has a high mass productivity is suitable. The polyester-based elastomer is excellent in heat resistance and low-temperature characteristics, and has a relatively stable flexibility even when the temperature changes.

Elastic support members 15A to 15D each include: movable-side connection part 151 that is fixed to lens holder 11; fixed-side connection part 152 that is fixed to magnet holder 12; and arm parts 153A and 153B that are elastically deformed in accordance with movement of lens holder 11.

Movable-side connection part 151 has a shape corresponding to engagement part 113a of lens holder 11. Movable-side connection part 151 is fitted to engagement part 113a of lens holder 11 and is fixed thereto by, for example, adhesion. Movable-side connection part 151 has an I-shape, and holds engagement part 113a of lens holder 11 from the light reception side and the image formation side in the optical axis direction. Thus, movable-side connection part 151 is firmly fixed to engagement part 113a of lens holder 11. Movable-side connection part 151 is displaced together with lens holder 11 when lens holder 11 moves in the optical axis direction.

Fixed-side connection part 152 has a shape corresponding to engagement part 126a of magnet holder 12. Fixed-side connection part 152 is fitted to engagement part 126a of magnet holder 12 and is fixed thereto by, for example, adhesion. In a state in which elastic support members 15A to 15D are attached, clearance C1 corresponding to a movement stroke to the image formation side in the optical axis direction is formed between stopper part 126b and movable-side connection part 151 of elastic support members 15A to 15D. The movement of lens holder 11 to the image formation side in the optical axis direction is regulated by movable-side connection parts 151 of elastic support members 15A to 15D abutting on stopper parts 126b of magnet holder 12.

Arm parts 153A and 153B are disposed so as to be separated from each other in the optical axis direction. Arm parts 153A and 153B are disposed so as to hold reinforcement protrusion part 113b of lens holder 11 therebetween in the optical axis direction.

Arm parts 153A and 153B are bent around first hinge shafts 154A and 154B and second hinge shafts 155A and 155B. That is, arm parts 153A and 153B have a two-axis hinge structure that allows parallel movement of lens holder 11.

Specifically, first hinge shafts 154A and 154B and second hinge shafts 155A and 155B are hinge grooves formed on the inner surfaces of arm parts 153A and 153B so as to be thinner than their surroundings. The shape of the hinge groove is not particularly limited, but the hinge groove preferably has a round shape. By adopting a mechanical hinge structure that utilizes the elasticity of the elastic resin material, it is possible to move lens holder 11 with a small force and to achieve power saving.

Further, arm parts 153A and 153B are separated from lens holder 11 and magnet holder 12 via clearances C21 and C22 in plan view (see FIG. 10). Thus, arm parts 153A and 153B can be deformed in the optical axis direction without interfering with lens holder 11 and magnet holder 12.

The elastic resin material such as an elastomer has a relatively large thermal expansion coefficient. Accordingly, the higher the ambient temperature, the longer arm parts 153A and 153B extends in the extension direction. In the present embodiment, elastic support members 15A to 15D are arranged such that movable-side connection parts 151 thereof and fixed-side connection parts 152 thereof are alternately located in the circumferential direction around the optical axis. That is, in a case where a thermal expansion occurs in elastic support members 15A to 15D, the expansion toward the same direction in the circumferential direction occurs. Thus, even when a thermal expansion occurs in elastic support members 15A to 15D occurs, lens holder 11 is displaced so as to rotate in the circumferential direction, in which case no displacement or twist in the shift direction occurs and an optical axis deviation is prevented.

Further, elastic support members 15A to 15D are evenly arranged around lens holder 11 so as to be 90° rotationally symmetric. That is, elastic support members 15A to 15D have a positional relation that allows mutual absorption of a thermal expansion generated in each of elastic support members 15A to 15D. Thus, it is possible to effectively prevent an optical axis deviation when a thermal expansion occurs in elastic support members 15A to 15D.

Base 21 has a rectangular shape in plan view, and includes opening 211 that has a circular shape and is formed in the center of base 21. In camera module A, image sensor board 41 in which image-capturing element 42 is implemented is disposed on the image formation side in the optical axis direction of base 21. For example, terminal fittings (whose reference sign is omitted) are embedded in base 21 by insert-molding. The terminal fittings are electrically connected to the wiring of image sensor board 41. Further, the terminal fittings are exposed from the four corners of base 21 and are connected to the other ends of suspension wires 24 by soldering.

OIS coils 23A to 23D are disposed at positions facing driving magnets 14A to 14D in the optical axis direction. OIS coils 23A to 23D are air-core coils in which current flows during shake correction. OIS coils 23A and 23C are hard-wired together and OIS coils 23B and 23D are hard-wired together, and the same current flows therein. Driving magnets 14A and 14C and OIS coils 23A and 23C form an OIS voice coil motor that sways OIS movable part M1 in the first direction (the direction orthogonal to the optical axis direction). Further, driving magnet 14B and 14D and OIS coils 23B and 23D form an OIS voice coil motor that sways OIS movable part M1 in the second direction (the direction orthogonal to the optical axis direction and the first direction).

Note that, detection parts, such as magnetic sensors, that detect the sway of OIS movable part M1 within the XY plane and movement of AF movable part M2 in the optical axis direction may be implemented in base 21. The magnetic sensor is formed of, for example, a Hall element, a tunnel magneto resistance (TMR) sensor, or the like

Suspension wire 24 is a linear member extending in the optical axis direction and is elastically deformed in accordance with the sway of OIS movable part M1. One end of suspension wire 24 (the end part on the light reception side in the optical axis direction; the upper end) is fixed to OIS movable part M1 (magnet holder 12 in the present embodiment) and the other end of suspension wire 24 (the end part on the image formation side in the optical axis direction) is fixed to OIS fixing part F1 (base 21 in the present embodiment). In the present embodiment, two of four suspension wires 24 and wirings 125 of magnet holder 12 are used as power supply paths to AF coils 13A to 13D.

In a case where shake correction is performed in optical element driving apparatus 1, current flows in OIS coils 23A to 23D. Specifically, in OIS driving part D1, the current flowing in OIS coils 23A to 23D is controlled based on a detection signal from a shake detection part (whose illustration is omitted; for example, a gyro sensor) so as to offset a shake of camera module A. At this time, feedback on a detection result of a magnetic sensor (whose illustration is omitted) makes it possible to accurately control the sway of OIS movable part M1.

When current flows in OIS coils 23A to 23D, Lorentz force is generated on OIS coils 23A to 23D by an interaction between the magnetic fields of driving magnets 14A to 14D and the current flowing in OIS coils 23A to 23D (Fleming’s left-hand rule). The direction of the Lorentz force is directions (the second direction and the first direction) orthogonal to the direction (the Z direction) of the magnetic fields at the long side portions of OIS coils 23A to 23D and the directions (the first direction and the second direction) of the current. Since OIS coils 23A to 23D are fixed, a reaction force acts on driving magnets 14A to 14D. This reaction force serves as the driving force of the OIS voice coil motor and OIS movable part M1 including driving magnets 14A to 14D sways within the XY plane and shake correction is performed.

In a case where auto-focusing is performed in optical element driving apparatus 1, current flows in AF coils 13A to 13D. The power supply to AF coils 13A to 13D is performed from base 21 via suspension wires 24, wirings 125, and the control IC (whose illustration is omitted). In a case where current flows in AF coils 13A to 13D, Lorentz force is generated on AF coils 13A to 13D by an interaction between the magnetic fields of driving magnets 14A to 14D and the current flowing in AF coils 13A to 13D. The direction of the Lorentz force is a direction (the Z direction) orthogonal to the direction of the magnetic fields by driving magnets 14A to 14D and the direction of the current flowing in AF coils 13A to 13D. Since driving magnets 14A to 14D are fixed, a reaction force acts on AF coils 13A to 13D. This reaction force serves as the driving force of the AF voice coil motor, and lens holder 11 (AF movable part M2) in which AF coils 13A to 13D are disposed moves in the optical axis direction and auto-focusing is performed.

Note that, when auto-focusing is not performed and current does not flow, AF movable part M2 (lens holder 11) is held, for example, in a state of being hung between an infinity position and a macro position (hereinafter this state will be referred to as “reference state”). That is, AF movable part M2 is elastically supported by AF support part S2 so as to be displaceable to the both sides in the Z-direction in a state in which AF movable part M2 is positioned with respect to AF fixing part F2 (magnet holder 12). When auto-focusing is performed, the direction of the current is controlled in accordance with whether lens holder 11 is moved from the reference state to the macro position side or to the infinity position side. Further, the magnitude of the current is controlled in accordance with the movement distance (stroke) of lens holder 11 from the reference state.

As described above, optical element driving apparatus 1 includes: AF fixing part F2; AF movable part M2 that allows lens part 2 (optical element) to be held therein; a plurality of elastic support members 15A to 15D that supports AF movable part M2 with respect to AF fixing part F2; and AF driving part D2 that moves AF movable part M2 in a direction of an optical axis. The plurality of elastic support members 15A to 15D is formed of an elastic resin material, and each of the plurality of elastic support members 15A to 15D includes movable-side connection part 151, which is connected to AF movable part M2, and fixed-side connection part 152, which is connected to AF fixing part F2. A plurality of movable-side connection parts 151 and a plurality of fixed-side connection parts 152 are alternately arranged in a circumferential direction around the optical axis.

According to optical element driving apparatus 1, even when a thermal expansion occurs in elastic support members 15A to 15D, lens holder 11 is displaced so as to rotate in the circumferential direction, in which case no displacement or twist in the shift direction occurs and an optical axis deviation is prevented. Accordingly, appropriate shake correction is performed and it is possible to achieve an improved image-capturing accuracy.

Further, in optical element driving apparatus 1, elastic support members 15A to 15D are arranged so as to be rotationally symmetric. Specifically, elastic support members 15A to 15D are arranged so as to be 90° rotationally symmetric. Thus, it is possible to effectively prevent an optical axis deviation when a thermal expansion occurs in elastic support members 15A to 15D.

Further, in optical element driving apparatus 1, each of elastic support members 15A to 15D includes arm parts 153A and 153B that couple movable-side connection part 151 and fixed-side connection part 152 together. Arm parts 153A and 153B have a two-axis hinge structure. By adopting a mechanical hinge structure that utilizes the elasticity of the elastic resin material, it is possible to move lens holder 11 with a small force and to achieve power saving.

Further, arm parts 153A and 153B are separated from AF movable part M2 and AF fixing part F2. Thus, arm parts 153A and 153B can be deformed in the optical axis direction without interfering with lens holder 11 and magnet holder 12.

While the invention made by the present inventors has been specifically described thus far based on the preferred embodiment, the present invention is not limited to the preferred embodiment described above and can be modified without departing from the gist thereof.

For example, although smartphone M that is a camera-equipped mobile terminal has been described as an example of the camera-mounted apparatus including camera module A in the preferred embodiment, the present invention is applicable to a camera-mounted apparatus that is an information device or a transport device. The camera-mounted apparatus that is an information device is an information device including: a camera module; and a control part that processes image information obtained by the camera module. Examples of the information device include a camera-equipped mobile phone, a notebook personal computer, a tablet terminal, a mobile game machine, a webcam, and a camera-equipped in-vehicle apparatus (such as a rear-view monitor apparatus and a dashboard camera apparatus). Further, the camera-mounted apparatus that is a transport device is a transport device including: a camera module; and a control part that processes an image obtained by the camera module. Examples of the transport device include an automobile.

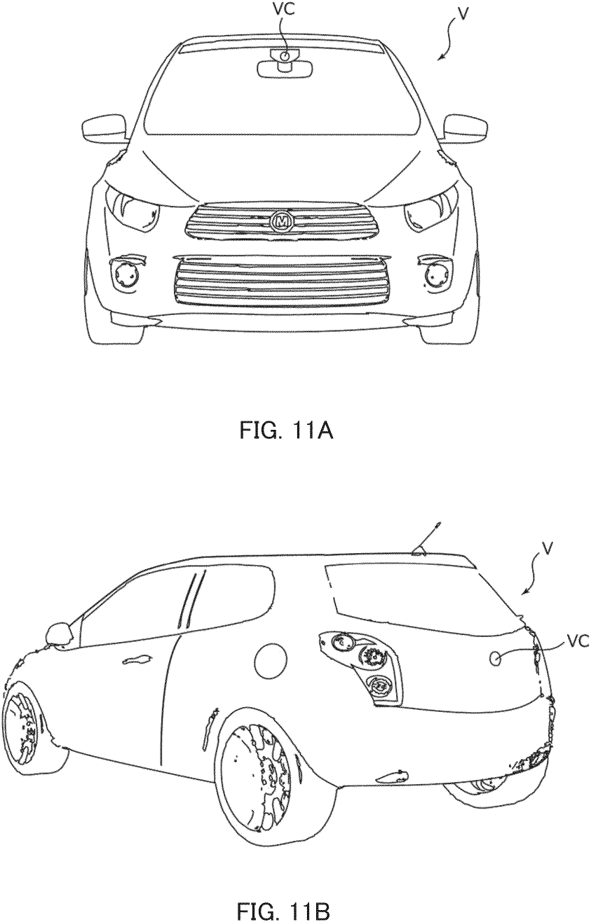

FIGS. 11A and 11B illustrate automobile V as a camera-mounted apparatus in which in-vehicle camera module vehicle camera (VC) is mounted. FIG. 11A is a front view of automobile V, and FIG. 11B is a rear perspective view of automobile V. In automobile V, camera module A described in the preferred embodiment is mounted as in-vehicle camera module VC. As illustrated in FIGS. 11A and 11B, in-vehicle camera module VC is attached to the windshield so as to face the front side, or is attached to the rear gate so as to face the rear side, for example. This in-vehicle camera module VC is used for a rear-view monitor, a dashboard camera, collision-prevention control, automated driving control, and the like.

Further, for example, the configurations of OIS driving part D1 and AF driving part D2 are not limited to those described in the preferred embodiment, and can be appropriately changed. For example, it is also possible to apply an ultrasonic motor system instead of a voice coil motor system for OIS driving part D1 and AF driving part D2.

The embodiment disclosed herein is merely an exemplification in every respect and should not be considered as limitative. The scope of the present invention is specified not by the description provided above, but by the appended claims, and is intended to include all modifications in so far as they are within the scope of the appended claims or the equivalents thereof.

### REFERENCE SIGN LIST

1 Optical element driving apparatus
2 Lens part
11 Lens holder
12 Magnet holder
13A to 13D AF coil
14A to 14D Driving magnet
15A to 15D Elastic support member
21 Base
23A to 23D OIS coil
24 Suspension wire
D2 AF driving part (driving part)
F2 AF fixing part (fixing part)
M2 AF movable part (movable part)
S2 AF support part
M Smartphone
A Camera module

What is claimed is:

1. An optical element driving apparatus, comprising:
a fixing part;
a movable part that allows an optical element to be held therein;
a plurality of support members that supports the movable part with respect to the fixing part; and
a driving part that moves the movable part in a direction of an optical axis, wherein
the plurality of support members is formed of an elastic resin material, each of the plurality of support members including a movable-side connection part and a fixed-side connection part, the movable-side connection part being connected to the movable part, the fixed-side connection part being connected to the fixing part, and
a plurality of the movable-side connection parts and a plurality of the fixed-side connection parts are alternately arranged in a circumferential direction around the optical axis.

2. The optical element driving apparatus according to claim 1, wherein the plurality of support members is arranged so as to be rotationally symmetric.

3. The optical element driving apparatus according to claim 2, wherein the plurality of support members is arranged so as to be 90° rotationally symmetric.

4. The optical element driving apparatus according to claim 1, wherein:
each of the plurality of support members includes an arm part that couples the movable-side connection part and the fixed-side connection part together, and
the arm part has a two-axis hinge structure.

5. The optical element driving apparatus according to claim 4, wherein the arm part is separated from the movable part and the fixing part.

6. A camera module, comprising:
the optical element driving apparatus according to claim 1;
a lens part that is attached to the movable part; and
an image-capturing part that captures a subject image formed by the lens part.

7. A camera-mounted apparatus that is an information device or a transport device, the camera-mounted apparatus comprising:
the camera module according to claim 6; and
a control part that controls an operation of the camera module.
